(19) United States
(12) Patent Application Publication
(10) Pub. No.: US 2026/0078787 A1
(43) Pub. Date: Mar. 19, 2026

(54) CONNECTOR FOR CONNECTING CABINET'S HORIZONTAL PLATES

(71) Applicant: Shenzhen Eco Packaging Co., Ltd, Shenzhen (CN)

(72) Inventor: Jia He, Huanggang (CN)

(73) Assignee: Shenzhen Eco Packaging Co., Ltd, Shenzhen (CN)

(21) Appl. No.: 19/324,050

(22) Filed: Sep. 9, 2025

(30) Foreign Application Priority Data
Sep. 13, 2024 (CN) 202422251223.7

(51) Int. Cl. F16B 12/20

(52) U.S. Cl. CPC F16B 12/20

(57) ABSTRACT

The present invention discloses a connector for connecting cabinet’s horizontal plates, comprising a subordinate connector and a principal connector, the subordinate connector including a fixing block, a first cross-shaped insertion column, a sub-U-shaped groove and a jamming groove, the principal connector including a principal U-shaped groove, a jammed protrusion, a connecting block and a second cross-shaped insertion column, the first cross-shaped insertion column being fixedly mounted close to both sides of a rear surface of the fixing block respectively, a sub-U-shaped groove being fixedly mounted on a front surface of the fixing block, and the jamming groove being disposed on a front surface and an inner side of the sub-U-shaped groove respectively. It is possible for the connector to avoid two plates at 90°from being frequently connected with each other, make assembling and disassembling convenient, without extra protrusion after assembly and with aesthetic; and save space during transportation.

### FIELD OF THE INVENTION

The present invention relates to the technical field of connection structure for cabinets, especially to a connector for connecting cabinet’s horizontal plates.

### BACKGROUND OF THE INVENTION

At present, it is necessary to connect two plates of a cabinet on the market, which is perpendicular to each other, by means of screws or glue or insertion; but it is not easy to assemble plates by way of connecting the plates by means of screws, nor capable of disassembling them; it is incapable of disassembling plates by way of connecting the plates by means of glue; a protrusion will occur unlovely to plates by way of connecting the plates by means of insertion. Therefore, we propose a connector for connecting cabinet’s horizontal plates.

### SUMMARY OF THE INVENTION

The main objective of the present invention mainly consists in providing a connector for connecting cabinet’s horizontal plates, which can effectively solve the problem in the background art.

In order to achieve the objective, the technical solution adopted by the present invention is as follows.

A connector for connecting cabinet’s horizontal plates includes a subordinate connector and a principal connector, and the subordinate connector includes a fixing block, a first cross-shaped insertion column, a sub-U-shaped groove and a jamming groove, and the principal connector includes a principal U-shaped groove, a jammed protrusion, a connecting block and a second cross-shaped insertion column.

Further, the first cross-shaped insertion column is fixedly mounted close to both sides of a rear surface of the fixing block respectively, and the sub-U-shaped groove is fixedly mounted on a front surface of the fixing block, and the jamming groove is disposed on a front surface and an inner side of the sub-U-shaped groove respectively.

Further, the jammed protrusion is disposed on a rear surface and an inner front side of the principal U-shaped groove respectively, and the connecting block is fixedly mounted on a front surface of the principal U-shaped groove, and the second cross-shaped insertion column is fixedly mounted close to both sides of an upper surface of the connecting block respectively.

Further, the jammed protrusion fits in the jamming groove, and the principal U-shaped groove and the sub-U-shaped groove fit in each other.

Compared with the prior art, the present invention has the following beneficial effects.

In the present invention, it is possible for the connector for connecting cabinet’s horizontal plates to solve the problem that two plates perpendicular to each other are frequently connected with each other, make it convenient to assembly and disassembly such a connector, without extra protrusion after assembly, and make it look more beautiful; in addition, because of quickly disassembling the connected plates structurally, it is possible to save space during transportation.

### BRIEF DESCRIPTION OF THE DRAWINGS

FIG. 1 is a structural diagram of the connector for connecting cabinet’s horizontal plates according to the present invention.

FIG. 2 is an exploded view showing how to assembly the subordinate connector and the principal connector of the connector for connecting cabinet’s horizontal plates according to the present invention.

FIG. 3 is an exploded view showing how to fit together the subordinate connector and the principal connector of the connector for connecting cabinet’s horizontal plates according to the present invention.

wherein, 1-subordinate connector; 101-fixing block; 102-first cross-shaped insertion column; 103-sub-U-shaped groove; 104-jamming groove; 2-principal connector; 201-principal U-shaped groove; 202-jammed protrusion; 203-connecting block;204-second cross-shaped insertion column.

### DETAILED DESCRIPTION OF SOME EMBODIMENTS

In order to make it easy to understand the technical solution, characteristics, objective and effect of the present invention, we shall further describe the present invention in combination with specific embodiments as follows.

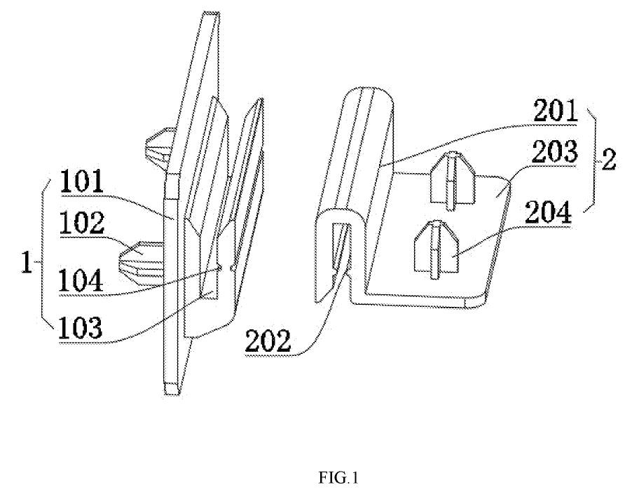

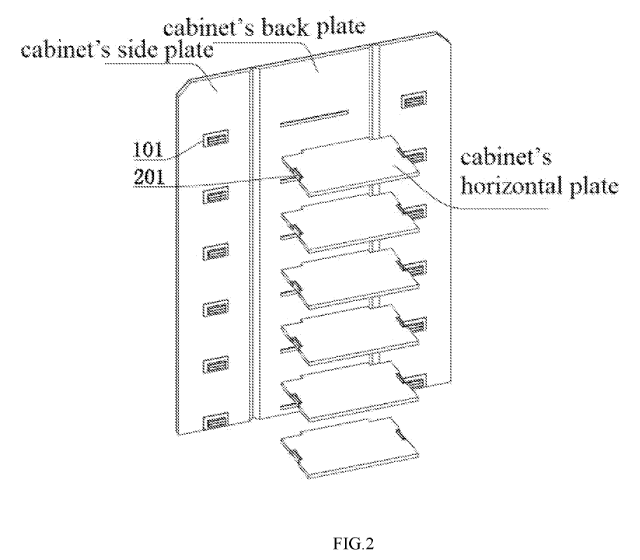

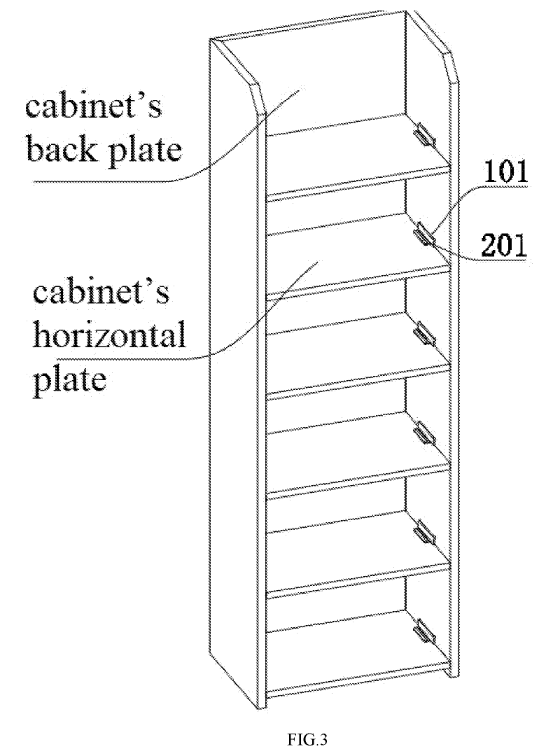

As shown in FIGS. 1-3, a connector for connecting cabinet’s horizontal plates includes a subordinate connector 1 and a principal connector 2, and the subordinate connector 1 includes a fixing block 101, a first cross-shaped insertion column 102, a sub-U-shaped groove 103 and a jamming groove 104, and the principal connector 2 includes a principal U-shaped groove 201, a jammed protrusion 202, a connecting block 203 and a second cross-shaped insertion column 204. Wherein the first cross-shaped insertion column 102 and the second cross-shaped insertion column 204 are fixed through insertion into a blind hole, and after insertion the blind hole applies a squeezing force both on the first cross-shaped insertion column 102 and the second cross-shaped insertion column 204, avoiding removal from the blind hole.

The first cross-shaped insertion column 102 is fixedly mounted close to both sides of a rear surface of the fixing block 101 respectively, and the sub-U-shaped groove 103 is fixedly mounted on a front surface of the fixing block 101, and the jamming groove 104 is disposed on a front surface and an inner side of the sub-U-shaped groove 103 respectively. The jammed protrusion 202 is disposed on a rear surface and an inner front side of the principal U-shaped groove 201 respectively, and the connecting block 203 is fixedly mounted on a front surface of the principal U-shaped groove 201, and the second cross-shaped insertion column 204 is fixedly mounted close to both sides of an upper surface of the connecting block 203 respectively. The jammed protrusion 202 fits in the jamming groove 104, wherein the jammed protrusion 202 is jammed into the jamming groove 104, so as to function in fixing and locking and make connection more stable. The principal U-shaped groove 201 and the sub-U-shaped groove 103 fit in each other.

It should be noted that in order to apply the connector for connecting cabinet’s horizontal plates according to the present invention, during assembling it is necessary to open a blind hole on a cabinet’s side plate and a cabinet’s horizontal plate respectively, and then insert the subordinate connector 1 into the blind hole on the cabinet’s side plate through first cross-shaped insertion column 102 to fix it with the cabinet’s side plate, and in the same way, insert the second cross-shaped insertion column 204 into the blind hole on the cabinet’s horizontal plate to fix the principal connector 2 with the cabinet’s horizontal plate; after installation, it is only necessary to insert an insertion plate behind the cabinet’s horizontal plate into a hole on a cabinet’s back plate, and then jam the principal U-shaped groove 201 set on both sides of the cabinet’s horizontal plate in the sub-U-shaped groove 103 and compress it, then make the jammed protrusion 202 fit in the jamming groove 104 simultaneously. In this way, it is possible to quickly finish fixation and make operation simple and convenient, and it is only necessary to pull out the principal connector 2 during disassembling; thereupon making it impossible to damage the cabinet during disassembly, and convenient to transport it after disassembly.

The above description shows and describes the basic principle and main features, and the advantages, of the present invention. A person skilled in the art should understand that the present invention is free of limitations of the above embodiments, and the above embodiments and the description in the specification only describe the principle of the present invention, so under the premise of not departing from the essence and scope of the present invention, various changes and improvements may also be made to the present invention, and such changes and improvements fall within the protection scope of the present invention. The protection scope of the present invention is defined by the attached claims and their equivalents.

What is claimed is:

1. A connector for connecting cabinet’s horizontal plates comprising: a subordinate connector (1) and a principal connector (2), the subordinate connector (1) including a fixing block (101), a first cross-shaped insertion column (102), a sub-U-shaped groove (103) and a jamming groove (104), and the principal connector (2) including a principal U-shaped groove (201), a jammed protrusion (202), a connecting block (203) and a second cross-shaped insertion column (204).

2. The connector for connecting cabinet’s horizontal plates according to claim 1, wherein the first cross-shaped insertion column (102) is fixedly mounted close to both sides of a rear surface of the fixing block (101) respectively, and the sub-U-shaped groove (103) is fixedly mounted on a front surface of the fixing block (101), and the jamming groove (104) is disposed on a front surface and an inner side of the sub-U-shaped groove(103) respectively.

3. The connector for connecting cabinet’s horizontal plates according to claim 2, wherein the jammed protrusion (202) is disposed on a rear surface and an inner front side of the principal U-shaped groove (201) respectively, and the connecting block (203) is fixedly mounted on a front surface of the principal U-shaped groove (201), and the second cross-shaped insertion column (204) is fixedly mounted close to both sides of an upper surface of the connecting block (203) respectively.

4. The connector for connecting cabinet’s horizontal plates according to claim 3, wherein the jammed protrusion (202) fits in the jamming groove (104), and the principal U-shaped groove (201) and the sub-U-shaped groove (103) fit in each other.
